(19) United States
(12) Patent Application Publication
(10) Pub. No.: US 2017/0319904 A1
(43) Pub. Date: Nov. 9, 2017

(54) INTERACTIVE PERFORMANCE FEEDBACK FOR EXERCISE EQUIPMENT

(71) Applicant: Western Michigan University Research Foundation, Kalamazoo, MI (US)

(72) Inventors: Neil Deochand, Kalamazoo, MI (US); Dale Gregory, Kalamazoo, MI (US); R. Wayne Fuqua, Kalamazoo, MI (US)

(21) Appl. No.: 15/597,896

(22) Filed: May 17, 2017

Related U.S. Application Data
(63) Continuation-in-part of application No. 15/092,176, filed on Apr. 6, 2016.
(60) Provisional application No. 62/143,417, filed on Apr. 6, 2015.

(51) Int. Cl. A63B 24/00; A63B 71/06; G06Q 10/06; A63B 69/32

(52) U.S. Cl. CPC A63B 24/0062; G06Q 10/0639; A63B 71/0622; A63B 69/32

(57) ABSTRACT

A method and device for providing performance feedback to a user during a session of using exercise equipment including measuring user input during the session using at least one sensor to gather sensor data, and transmitting the sensor data to a processing device. The sensor data is evaluated to determine at least one of a force metric, a frequency metric, and an accuracy metric. The at least one of the force metric, the frequency metric and the accuracy metric are compared to at least one predetermined performance goal. Audio and/or visual feedback is provided to the user based on the comparison of the at least one of the force metric, the frequency metric, and the accuracy metric with the at least one predetermined performance goal. The audio feedback includes varying a musical playback in at least one of speed, volume, and pitch.

### CROSS-REFERENCE TO RELATED APPLICATIONS

This application is a Continuation-in-Part of U.S. patent application Ser. No. 15/092,176 filed on Apr. 6, 2016, entitled “INTERACTIVE PERFORMANCE FEEDBACK FOR EXERCISE EQUIPMENT,” which claims the benefit of U.S. Provisional Application No. 62/143,417 filed on Apr. 6, 2015, entitled, “INTERACTIVE PERFORMANCE FEEDBACK FOR EXERCISE EQUIPMENT,” the entire contents of each of which are incorporated herein by reference.

### FIELD OF THE INVENTION

The present disclosure relates to a system and method for providing interactive performance feedback to a user of exercise equipment.

### BACKGROUND OF THE INVENTION

Immediate feedback on athletic performance can be helpful to allow users to determine whether their athletic performance is improving or being maintained at a desired level, and can provide safety benefits such as warning a user when equipment is being used incorrectly. The ability to provide immediate feedback on physical activities also allows for researchers or trainers to study the effectiveness of feedback, including immediate or real-time feedback, on athletic performance, allowing researchers or trainers to determine more effective feedback for users to improve athletic performance.

### SUMMARY OF THE INVENTION

One aspect of the present disclosure is a method of providing interactive performance feedback for a user during a session of using exercise equipment including measuring user input during the session using at least one sensor to gather sensor data and transmitting the sensor data to a processing device. The sensor data is evaluated to determine at least one of a force metric, a frequency metric, and an accuracy metric. The at least one of the force metric, the frequency metric and the accuracy metric are compared to at least one predetermined performance goal. At least one of audio and visual feedback is provided to the user during the session based on the comparison of the at least one of the force metric, the frequency metric, and the accuracy metric with the at least one predetermined performance goal.

Another aspect of the present disclosure is a system for providing interactive performance feedback including a unit of exercise equipment and at least one sensor operably attached to the unit of exercise equipment to gather sensor data regarding user input. The exercise equipment includes at least one transmitter to transmit the sensor data to a processing device. The processing device evaluates the sensor data to determine at least one of a force metric, a frequency metric and an accuracy metric and then compares the at least one of the force metric, the frequency metric and the accuracy metric to a predetermined performance goal. The processing device directs at least one of an audio feedback and a visual feedback to the user based on the user's attainment of the at least one predetermined performance goal.

Yet another aspect of the present invention includes an interactive performance feedback system for a punching bag, including a plurality of accelerometers affixed to the punching bag and operably coupled to at least one transmitter to provide measurements to the at least one transmitter regarding the motion of the punching bag. A processing device is operably coupled to the at least one transmitter to receive measurements from the accelerometers. The processing device evaluates the measurements from the accelerometers to determine at least one of a force metric, a frequency metric, and an accuracy metric and compares the at least one of the force metric, the frequency metric, and the accuracy metric to at least one predetermined performance goal. An audio feedback output is controlled by the processing device to provide audio feedback which varies in at least one of speed, volume, and pitch based on the comparison of the at least one of the force metric, the frequency metric, and the accuracy metric to the at least one predetermined performance goal.

These and other features, advantages, and objects of the present device will be further understood and appreciated by those skilled in the art upon studying the following specification, claims, and appended drawings.

### BRIEF DESCRIPTION OF THE DRAWINGS

FIG. 1 is a flow chart of a system for providing interactive performance feedback for a user of exercise equipment;

FIG. 2 is a flow chart illustrating one embodiment of the use of a baseline session to calculate predetermined performance goals.

FIG. 3 is a flow chart illustrating one embodiment of the use of user performance to update the predetermined performance goals;

FIG. 4 is a schematic view of one embodiment of a system for providing interactive performance feedback for a user of a punching bag;

FIG. 5 is a front elevation view of one embodiment of a punching bag for use in the system shown in FIG. 4;

FIG. 6 is a schematic view of the embodiment of the punching bag shown in FIG. 5;

FIG. 6A is an enlarged schematic view of a portion of the punching bag of FIG. 6;

FIG. 7 is a top perspective view of an accelerometer for use with the embodiment of a punching bag shown in FIG. 4;

FIG. 8 is an electronic schematic view of the accelerometer shown in FIG. 7;

FIG. 9 is a top plan view of a distribution board for use with the embodiment of a punching bag shown in FIG. 4;

FIG. 10 is an electronic schematic view of the distribution board shown in FIG. 9;

FIG. 11 is a flow chart of the main execution flow and process of polling the accelerometers for use with the embodiment of the punching bag shown in FIG. 4;

FIG. 12 is a general flow chart of a UART and a time interrupt handler for use with the embodiment of the punching bag shown in FIG. 4;

FIG. 13 is a graph illustrating typical accelerometer readings for a user's round on the embodiment of the punching bag shown in FIG. 4;

FIG. 14 is a schematic of a system that includes a punching bag and wearable sensors;

FIG. 14A is an enlarged view of a wearable sensor of FIG. 14;

FIG. 15 is a schematic view of a system that includes wearable sensors; and

FIG. 16 is a schematic view of a system including a treadmill and wearable sensors.

### DETAILED DESCRIPTION

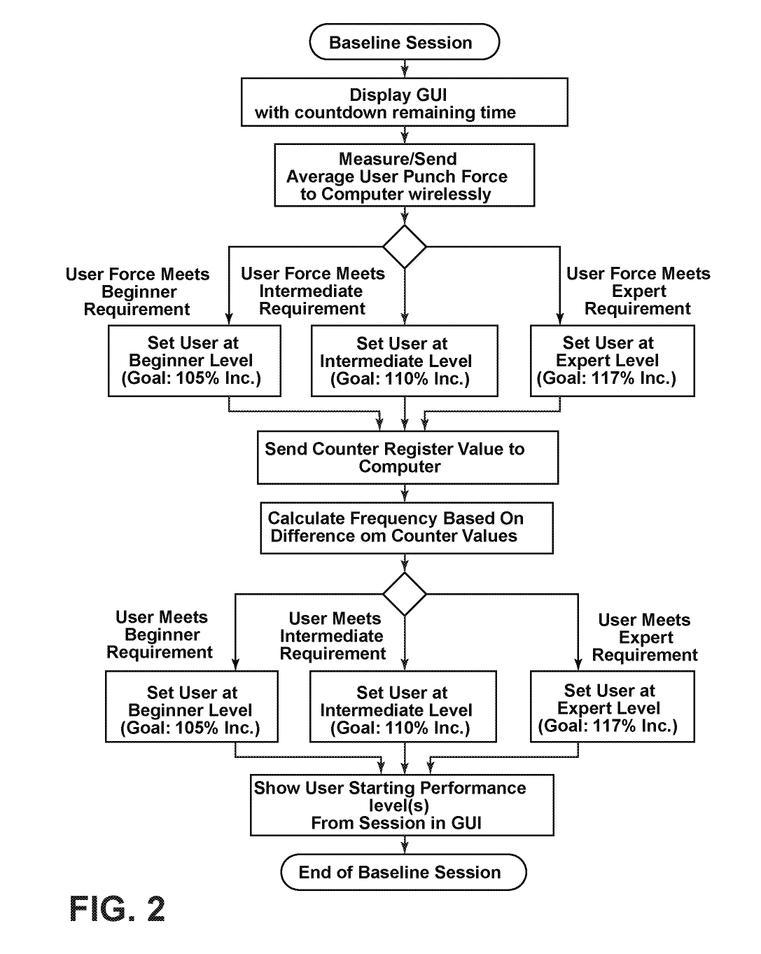

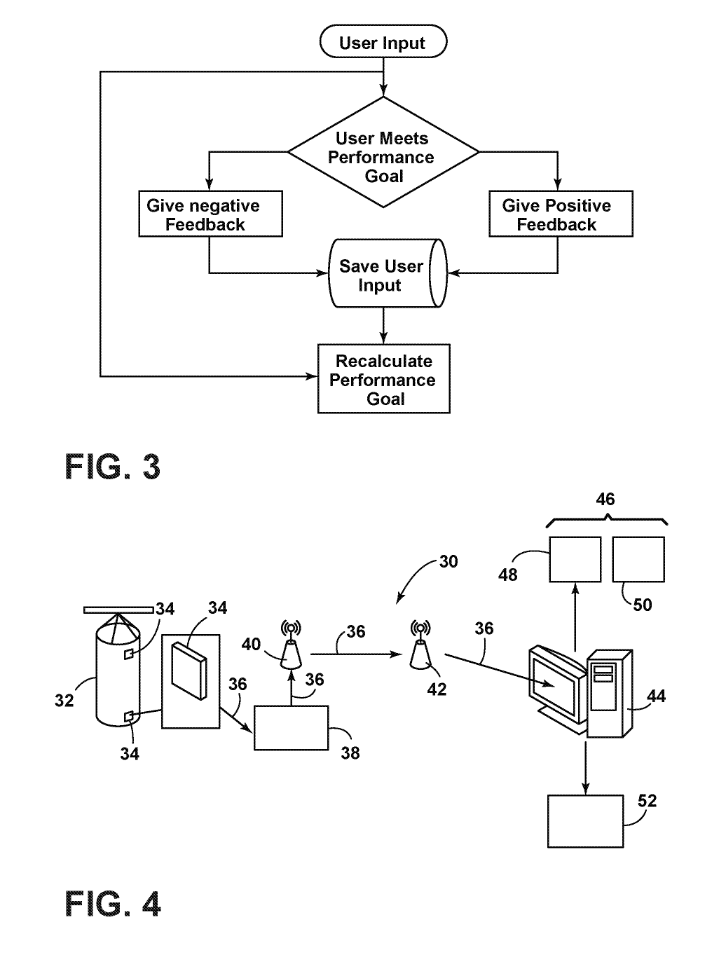

For purposes of description herein the terms “upper,” “lower,” “right,” “left,” “rear,” “front,” “vertical,” “horizontal,” and derivatives thereof shall relate to the system, device and components as shown in FIGS. 2 and 3. However, it is to be understood that the system, device, and components may assume various alternative embodiments and orientations and the methods for providing feedback to a user may include various step sequences, except where expressly specified to the contrary. It is also to be understood that the specific systems, compositions, devices and processes illustrated in the attached drawings, and described in the following specification are simply exemplary embodiments of the inventive concepts defined in the appended claims. Hence, specific compositions, dimensions and other physical characteristics relating to the embodiments disclosed herein are not to be considered as limiting, unless the claims expressly state otherwise.

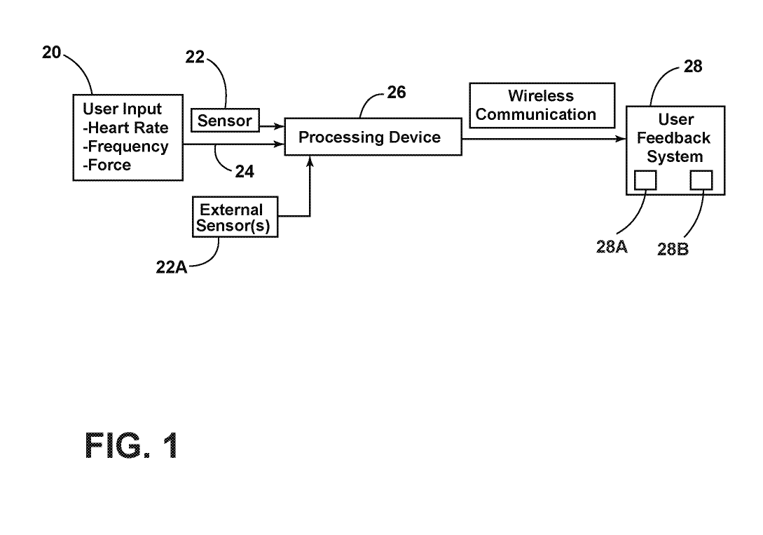

As shown in the embodiment depicted by the schematic in FIG. 1, the present disclosure relates to a device and method for providing performance feedback to a user of exercise equipment 20. At least one sensor 22 is used to detect user input (i.e., use of the exercise equipment 20) and to output sensor data 24. As discussed in more detail below, sensor 22 may comprise one or more sensors such as accelerometers 34 (FIG. 6) that are integrated into an exercise device or equipment. The sensor data 24 is transmitted to a processing device 26. The processing device 26 computes at least one of a force measurement, a frequency measurement, and an accuracy measurement from the sensor data 24. The processing device 26 compares at least one of the force measurement, the frequency measurement and the accuracy measurement with at least one predetermined performance goal to determine whether the at least one predetermined performance goal has been met by the user's performance. Predetermined performance goals can include goals for at least one of heart rate, force, frequency, and accuracy.

The processing device 26 further directs a user performance feedback system 28, which can give the user positive feedback or negative feedback (depending upon whether the at least one predetermined performance goal is being met). The user feedback system 28 preferably provides feedback to the user while the equipment 20 is in use, including optional audio feedback and visual feedback. Audio feedback may be provided by an audio feedback module/speaker 28A and visual feedback may be provided by a visual feedback module/screen 28B. The user feedback system 28 also optionally provides additional feedback to the user at the end of the round or session including more detailed or statistical information regarding the completed round. Visual feedback system 28B may comprise a display screen (e.g. a touch screen), and audio feedback module 28A may comprise speakers that are integrated into an exercise device. Alternatively, user feedback system 28 may comprise a laptop computer, a tablet computer, a smartphone, or other such device having speakers and/or a display screen. If a computer or smartphone is utilized, it may be operably connected to processing device 26 by a wireless connection. Alternatively, a computer that includes a processing device 26 and a user feedback system 28 may be utilized. Various examples of the types of exercise equipment 20 for use according to the present disclosure include, without limitation, a punching bag, free weights, a stationary bike, a treadmill, a rowing machine, a stair stepper machine, and an elliptical machine. In certain preferred embodiments, the sensors 22 on the exercise equipment 20 can be used in conjunction with another type of sensor, such as a heart rate monitor, which can also be used to send signals to the processing device 26.

In addition to (or instead of) one or more sensors 22 that are integrated into an exercise device, one or more external sensors 22A may also be utilized. Sensors 22A may comprise external devices such as wearable sensors, body camera sensors, or implantable sensor chips. Wearable sensors/monitors are devices worn on the body to detect and/or measure movement as it relates to the physical exercise. Numerous wearable fitness sensors/monitors are known in the art. 3-9 axis accelerometers are one type of wearable sensor. Accelerometers worn on the hands or angles can be utilized to detect time-indexed movement, allowing measurement of one or more of force, frequency, or accuracy of the physical activity. According to one aspect of the present disclosure, body camera sensors may be worn by a user to provide motion capture of body movement during exercise. This may be accomplished by collecting depth data within a three-dimensional field utilizing infra-red dot positioning to calculate the depth of pixilation in the red/green/blue spectrum. According to another aspect of the present disclosure, implantable sensors may be attached on or below the skin of the exerciser so that metrics of their physical exercise can be measured. For example, a sensor may be secured to an outer surface a user's skin utilizing adhesive.

In a preferred embodiment, sensor data 24 is transmitted to the processing device 26, where it is used to calculate at least one of the force metric, the frequency metric, and the accuracy metric. The at least one of the force metric, the frequency metric, and the accuracy metric are then compared by the processing device 26 to the at least one predetermined performance goal to determine whether the at least one predetermined performance goal has been met. Typically, a user will complete a session using the exercise equipment 20, which may or may not be broken into further sub-units, such as sets, repetitions, or rounds. The session may be a defined length of time, a distance traveled, the duration that the user is able to continue the activity, or other exercise metric. Where the use is divided into sub-units, performance goals can be set per session or per sub-unit, or can be cumulative, relating to each. The predetermined performance goals can be generic, i.e., can be pre-established without reference to the user's past performance. However, the predetermined performance goals are preferably based on a baseline performance evaluation of the user as further described below and intervening sessions completed by the same user. Additionally, the performance goals preferably incorporate improvement over time, or in repeated sessions, to encourage the user to increase strength, endurance, and skills through continued use of the exercise equipment 20. In certain embodiments, the processing device 26 is used to determine relative force, rather than a calibrated actual force, where the goal is to determine the overall improvement. The processing device 26, after determining whether the predetermined performance goals have been met, directs feedback to the user through the user feedback system 28. The feedback is preferably in real time, throughout the session that the user is engaged in, as further described below.

Processing device 26 may be programmed to evaluate music selected by the user, and recommend (e.g. via user's feedback system 28) an order of the music playlist based on the beats per minute of each song. According to the recommendation, slower paced songs may be played during the warm-up period, and faster paced songs may be played during more strenuous physical activity. Depending on the speed of the physical activity, the recommended songs may be selected by processing device 26 to match the pace of the physical activity. For example, music having 100-110 beats per minute (BPM) may be selected for walking (0-3 miles per hour), music having 110-140 BPM may be selected for jogging (4-6 miles per hour), and music having 140-160 BPM may be selected for running (>6 miles per hour).

In one embodiment, the audio and visual feedback are determined based on the average performance (e.g., average force, average frequency, average accuracy) of the user over a time period. To keep the feedback current, or in “real time” over the course of the user's session, the time period for determination of the average for feedback is less than the total time of the session. For example, in a session that is 3 minutes long, the average value of the relevant measurement over the most recent 5 second time period can be used. The processing device can continue to perform this calculation to determine a moving average and continue to update the feedback to the user.

In one embodiment, the user receives auditory feedback during each round or session. In a preferred embodiment, the user selects music to be played during the session (or the genre of music, or a musical station). During operation, at least one of the volume, frequency (tempo), or pitch of the music are adjusted to provide auditory feedback based on the user's attainment of at least one predetermined performance goals during the round or session. For example, if the user is below the predetermined performance goal for frequency, the tempo of the music is slowed. In another example, if the user is below the predetermined performance goal for force the volume of the music is lowered. In yet another example, if the user is below the predetermined performance goal for accuracy, the pitch of the music can be altered. Alternative combinations and configurations, e.g., altering the volume based on the frequency, can also be employed. However, it is preferable for each predetermined performance goal to be used to control a separate aspect of the audio feedback to allow the user to know in real time which aspect of the athletic performance is meeting the predetermined performance goal. The variation of the frequency (tempo), volume, and pitch of the music can be based on a linear relationship with the attainment of performance goals, or any other function, and a lower or upper limit can be placed, e.g., so the music does not fall below 90% of the tempo, volume, or pitch of the original.

In one preferred embodiment, a user or administrator creates an individual user profile prior to the user using the exercise equipment 20 as described herein. The user profile may contain information, for example, a user name, the user's age, the user's weight, the user's height, the user's fitness or experience level, or the user's musical preferences for auditory feedback. In addition to the general user profile, in the preferred embodiment predetermined force, frequency and accuracy performance goals are set for each user, as well as optional predetermined goals such as optimal heart rate. To set these predetermined performance goals, a baseline session can be used to determine the user's current fitness and skill level. In certain embodiments, the user's initial baseline fitness and skill level can be used to classify the user as a beginner, intermediate, or advanced user (or any other categories, such as level 1-5 users). An improved performance over that demonstrated by the user in the baseline session can be targeted with the predetermined performance goals with the percentage increase over the baseline session optionally influenced by the classification of the user's initial baseline fitness and skill level.

As shown in the embodiment depicted by the schematic in FIG. 2, the present disclosure also relates to determination of the predetermined performance goals for the user through the use of a baseline session to determine the user's current level of skill and experience using the exercise equipment 20. As shown in the embodiment depicted by the schematic in FIG. 3, the predetermined performance goals for the user are also updated over time, to account for changes in the user's skill and experience level, preferably improvements in the skill and performance level resulting from continued use of the exercise equipment 20.

In one embodiment, the predetermined performance goals are designed to target certain incremental percentage increases in force, frequency or accuracy metrics. As described herein, in a preferred embodiment, the incremental increase is predetermined based on the user's baseline fitness level. For example, a beginner user could have a given incremental increase for the predetermined performance goal, while an intermediate or advanced user has a different incremental increase for the predetermined performance goal. In an alternate embodiment, the user is able to select or enter a desired incremental increase. In yet another alternate embodiment, a trainer, fitness professional, or researcher could prepare a protocol to set the desired incremental increase in predetermined performance goals.

In the particular embodiment depicted by the schematic in FIG. 2, the user performs a “baseline session” using the exercise equipment during which time the user is being monitored, but is not receiving audio or visual feedback regarding performance goals. The user is optionally shown a visual display with information such as the remaining time in the session. In one preferred embodiment, the length of the baseline session is a 3-minute round, for example, where the exercise equipment is a punching bag. In an alternate embodiment, the length of the baseline session is chosen to correspond to a typical user exercise session. The exercise equipment monitors the user's performance during the baseline session. Based on the results of the baseline session, i.e., the at least one force metric, frequency metric, and accuracy metric, the user's initial performance level is displayed to the user, and the at least one predetermined performance goal for the next session is calculated based off of the initial performance level during the baseline session and the desired increase in performance.

In one non-limiting example, the exercise equipment 20 may comprise a punching bag. The average force of the user's strikes against the punching bag may be sensed by the sensors 22, and the sensor data may be utilized to classify the user as a beginner, intermediate or expert level user. Based on the user's level, the goal for increases in force can be varied, e.g., 105% increase for beginners, 110% increase for intermediates, and 117% increase for experts. Additionally, or alternatively, the user can be classified as a beginner, intermediate, or expert level user based on the strike frequency or upon the user strike accuracy.

Alternatively, the user or an administrator could enter a predetermined set of criteria. For example, if the exercise equipment 20 will be used for a fitness test with minimum requirements, those requirements could be set as the predetermined performance goals. These types of predetermined performance goals could be set with or without the use of a baseline session to evaluate the user.

With continued use of the exercise equipment 20, predetermined performance goals are updated to account for the user's continued improvement. As shown in the embodiment depicted in FIG. 3, as the user uses the exercise equipment 20, the processing device 26 evaluates the sensor data 24 provided by the sensor 22 to determine whether the user is meeting the current predetermined performance goals. The processing device 26 directs the user's feedback system 28, giving positive feedback if the at least one predetermined performance goal is being met and negative feedback if the at least one predetermined performance goal is not being met. The sensor data 24 is saved, and the predetermined performance goals for the next session are calculated based on the user's performance.

In certain embodiments, the predetermined performance goals can be decreased, can be increased, or can remain unchanged based on whether the user meets the at least one predetermined performance goal, or how far the user's performance varies from the at least one predetermined performance goal in the previous session. For example, if a user's performance is significantly better than the at least one predetermined performance goal in the previous session, the at least one predetermined performance goal for the next session may be increased more than if the user's performance barely exceeds the at least one predetermined performance goal in the previous session. Similarly, in certain embodiments if the user fails to meet the at least one predetermined performance goal, the at least one predetermined performance goal for the next session may remain the same. If the user fails to meet the at least one predetermined performance goal in one or more consecutive sessions, the at least one predetermined performance goal may be lowered for future sessions. The at least one predetermined performance goal can be varied using different increments for each of the attributes being measured, e.g., a different incremental increase in the predetermined performance goal for force (5%) versus the incremental increase in the predetermined performance goal for frequency (10%).

In various embodiments the predetermined performance goals can be added in a stepwise fashion. As one non-limiting example, the predetermined performance goals can begin with a goal only for force. As the user improves his or her force metric, the predetermined performance goals can be modified to also include a goal for frequency. As both of these factors improve, the predetermined performance goals can be modified to include an accuracy goal. This allows a user to focus on a certain aspect of performance until a desired level is reached, and stepwise incorporation of predetermined performance goals may be useful with certain types of exercise equipment 20 where endurance or strength must be built or a specific aspect of the skill must be mastered.

In one embodiment, the user receives visual feedback from the user feedback system 28 including a display of the at least one force metric, frequency metric, or accuracy metric. The display may comprise an image formed on an electronic display screen. The display can indicate the at least one force metric, frequency metric, or accuracy metric of the most recent strike, or can indicate the measurement for the moving average calculation during the session. In addition to or in place of this visual feedback, the display can include information regarding the elapsed time of the session or sub-unit, the time remaining in the session or sub-unit, the total number of strikes, steps, or repetitions in the session or sub-unit, the overall frequency or rate of strikes, steps or repetitions, the average accuracy metric, the average force metric, the minimum force metric, the maximum force metric, or other detailed data. The display can also optionally be used to display other detailed data regarding the user's previous session or sub-unit upon completion of the session or sub-unit.

The color of the writing, the background, or any other portion of the visual display can also be altered to indicate whether the predetermined performance goals (or at least one of the predetermined performance goals) are being met. For example, if the predetermined performance goals are being met, the background for the visual display may be a green color, while if the user's performance falls below 95% of the predetermined performance goal the display or a portion thereof changes to yellow and if the user's performance falls below 90% of the predetermined performance goal the display or a portion thereof changes to red. Alternative arrangements or cutoff points could also be used, such as switching to a warning color when the user's performance falls below at least one of the predetermined performance goals or when the user falls to a specified percentage above the at least one predetermined performance goal, or omitting the use of a warning color.

The visual display provided to a user can be modified based, at least in part, on a user's performance. For example, if the force, frequency and accuracy metrics meet a performance benchmark (performance goal) specified by the device or user, then the data display for recent strike force, frequency, and accuracy, or elapsed time, remaining sessions, or heart rate could be more visible. Alternatively, if a user's performance does not meet a predefined performance benchmark, the visibility of the backlight may be influenced so that the contrast ratio inhibits visibility, at least to some extent. If the system includes a television or virtual simulator, the contrast ratio of the television or virtual simulator may be decreased so that the visibility of the display is altered when the user is performing below their performance goal. To revert the display to normal, the user would have to perform at or above a predefined goal.

One embodiment of a system 30 for providing interactive performance feedback using a punching bag 32 is depicted in FIG. 4. The punching bag 32 is equipped with a plurality of sensors 34 to detect user input (i.e., strikes against the punching bag 32) and generate sensor data 36 regarding the user input. The punching bag 32 is further equipped with a microcontroller 38 to receive the sensor data 36 from the sensors 34 and to transmit the data 36 via a wireless communication transmitter 40 to a wireless communication receiver 42 which is operably connected to a processing device 44. The processing device 44 computes at least one of a force metric, a frequency metric, and an accuracy metric and compares the at least one of the force metric, the frequency metric, and the accuracy metric to the at least one predetermined performance goal to determine whether the predetermined performance goal has been met. The processing device 44 directs a feedback system 46 to the user regarding whether the user's performance meets, exceeds, or falls short of the predetermined performance goals. The performance feedback system 30 optionally includes an audio feedback module/speaker 48 and a visual feedback module/display screen 50. The processing device 44 also directs storage of the user's performance in a storage file 52 as measured by the force metric, the frequency metric, and the accuracy metric so that the data can be retrieved for viewing in the future and the data can be used to calculate future predetermined performance goals.

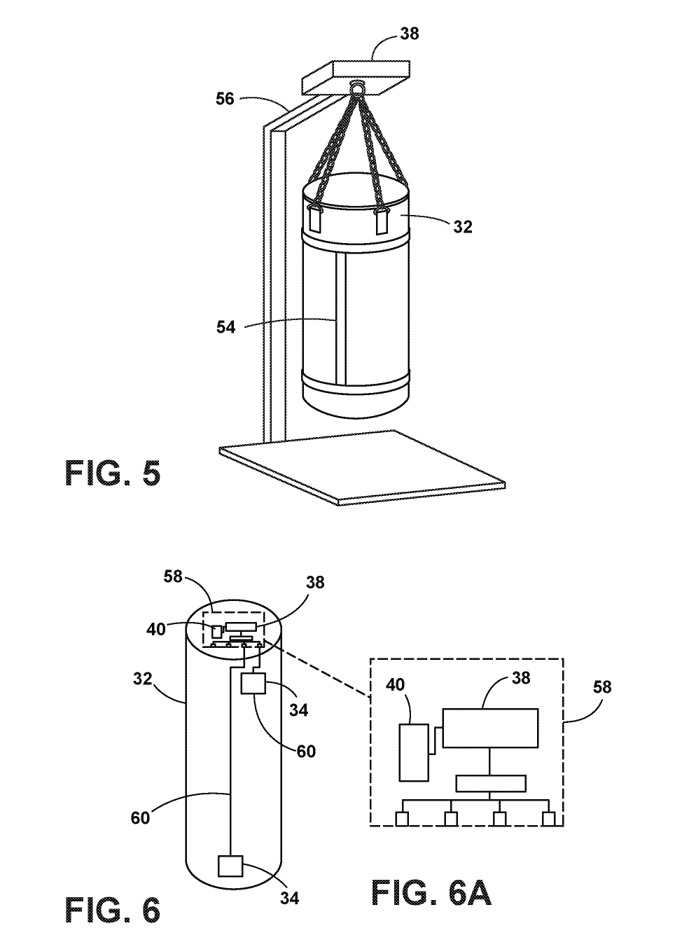

In the embodiment depicted in FIGS. 4-5, the sensors 34 used are accelerometers, and are secured to the punching bag 32 using one or more removable straps 54. Such straps can optionally be connected via hook and loop connectors, buttons, snaps, or can stretch over the punching bag 32. The microcontroller 38 is secured to a stand 56 for the punching bag 32, above the punching bag 32, where it will remain stable and out of the range of the user's strikes. In another embodiment, the sensors 34 and microcontroller 38 can be secured in a sheath, where the sheath is removable from the punching bag 32. In an alternate embodiment, the punching bag 32 can include an integrated system of sensors 34 and microcontroller 38.

Where accelerometers are used as the sensors 34, each accelerometer measures acceleration in three dimensions, allowing the data from the plurality of accelerometers to be used to calculate the force, the frequency, and the accuracy of the user's strikes. In one preferred embodiment, as shown in FIGS. 5-6, at least two accelerometers are positioned around the punching bag 32, with one sensor 34 near the top of the punching bag 32 and another sensor 34 near the bottom of the punching bag 32. In another preferred embodiment, four accelerometers are positioned around the punching bag 32. The use of multiple sensors 34 such as accelerometers in the design allows various factors contributing to the overall impact of the strike to be accounted for, such as the punching bag 32 swinging following previous strikes, and is therefore preferred over the use of a single accelerometer.

Where accelerometers are chosen as the sensors 34, to choose appropriate accelerometers for a given application and set of exercise equipment 20, testing can be undertaken to find out the force that will be applied by the user input to the exercise equipment 20, whether used with the punching bag 32 or another type of exercise equipment 20. The accelerometers are preferably calibrated individually, and then refined once positioned in the exercise equipment 20 through the use of methods such as using a motion capture system and comparing a motion capture database to sensor data 36 to develop an accurate tracking of motion of the punching bag 32 or other exercise equipment 20 using the accelerometer sensor data 36. Various accelerometers have different sensitivities and limits on their ability to detect acceleration. The accelerometers are optionally powered by a wired electrical connection. With a wired connection, a capacitor can be added between the ground and power of the accelerometer to reduce electronic noise. Where a wired connection is used, the SCLK, MOSI, and MISO pins of each accelerometer are electrically connected, with the individual chip select pins connected to GPIO pins on the microcontroller.

The accelerometers are calibrated to establish force readings generated by the user's strike by measuring the acceleration of the punching bag 32. The sensor data 36 regarding the acceleration of the punching bag 32 is transmitted to the processing device 44, and the processing device 44 can then use the sensor data 36 to calculate or determine the overall force of the strike on the punching bag 32. In one embodiment, the magnitude of the initial impulse is multiplied by the mass of the punching bag 32 to determine the force of the strike. In another embodiment the maximum force that occurs over the time of the strike is used to calculate the force of the strike. In many cases, the initial impulse will correspond with the largest spike in the accelerometer's output. In certain embodiments, relative force measurements (or calculations) can be reliably used, e.g., to allow the predetermined performance goals to target a percentage improvement in relative force over time.

Additionally, the frequency of the strikes can be calculated based upon the time measured between detected strikes in the sensor data 36. In order to detect the frequency of strikes on the punching bag 32, during the calibration of the accelerometers, a threshold acceleration can be incorporated such that sensor data 36 below the threshold acceleration is filtered from the sensor data 36, thereby allowing the sensor data 36 from the accelerometers to distinguish between a tap or push on the punching bag 32 and a full strike of the punching bag 32 as well as to filter out the effect of accelerometer noise. In one particular embodiment, to be considered a strike on the punching bag 32 a number of consecutive readings over a threshold value must be detected, with a predefined gap between one set of values above the threshold value and the next set of values above the threshold value to detect the next strike (to correspond to the maximum speed that humans are capable of striking the punching bag 32).

In addition to detecting the level of force and the frequency of the strikes, the location of the strike on the punching bag can also be determined based on the sensor data 36 from the accelerometer and the relative accelerations of the accelerometers. Accuracy is calculated through the comparison of acceleration magnitudes of accelerometers in different positions on the punching bag 32. The magnitude of the accelerometer reading will vary greatly between sensors 34 located near the bottom of the punching bag 32 and sensors 34 located near the top of the punching bag 32 based on the location of the strike. Through testing, a formula can be created to determine the location of a given strike based on these differences in sensor data 36 between the accelerometers. The processing device 44 can then compare the distance between the strike and predetermined points on the punching bag 32 to determine the accuracy of the strike (e.g., whether the strike is in a target zone).

In the embodiment depicted in FIGS. 5-6, the microcontroller 38 is used to gather sensor data 36 from the sensors 34, and transmit the sensor data 34 to the processing device 44 for data manipulation and storage. The microcontroller 38 is preferably positioned out of the range of likely strikes to the punching bag 32, such as positioned on a bottom surface of the punching bag 32, a top surface of the punching bag 32, or on a stand 56 for holding the punching bag 32. The microcontroller 38 could also optionally be positioned on a rear surface of the punching bag 32. The microcontroller 38 can be powered by a wired connection to an outlet or a battery. The microcontroller 38 is preferably a low-power device to optimize battery life and reduce the need to have a wired power source to power the microcontroller. Due to the high energy use associated with wireless transmission, the microcontroller 38 will also preferably include a separate battery pack electrically connected to the microcontroller 38, with a warning LED to illuminate when the battery power is low. An on/off switch to conserve power for the microcontroller is also preferred. The microcontroller also preferably includes at least one GPIO pin for each accelerometer that is used and a serial communication port to be used as the wireless communication transmitter 40 to transmit the sensor data 36 wirelessly to the processing device 44.

Also as shown in the embodiment depicted in FIGS. 5-6, the sensors 34 and microcontroller 38 are preferably contained in an electronic-safe harness, with the sensors 34 having a wired connection to a distribution board 58 that physically connects the hardware components of the sensors 34 and the microcontroller 38. In one embodiment, standard Ethernet cables 60 can be used to wire the sensors 34 to the distribution board 58. The distribution board 58 is preferably housed in a metal, plexiglass, or other protective container, and includes the microcontroller 38 and wireless communication transmitter 40 operably connected to the microcontroller 38 to transmit information to the processing device 44. In an alternate embodiment, the harness can include e-textiles using conductive thread to connect lilly-pad accelerometer sensors 34 and the microcontroller 38. Textile designs are more tolerant of environmental changes than printed circuit board designs and wired designs. In another embodiment, the sensors 34 and microcontroller 38 are battery-powered and capable of transmitting sensor data 36 wirelessly, to reduce the electronic components and the wiring that will be positioned on the punching bag 32, where it is subject to potential impact and moisture.

In one embodiment, the sensor data 36 is sent from the microcontroller 38 through the wireless communication transmitter 40 to a wireless communication receiver 42 which is operably connected to the processing device 44. In alternate embodiments, the microcontroller 38 and the processing device 44 can communicate through alternative wired or wireless connections, such as using Bluetooth, WiFi, or other communication protocols.

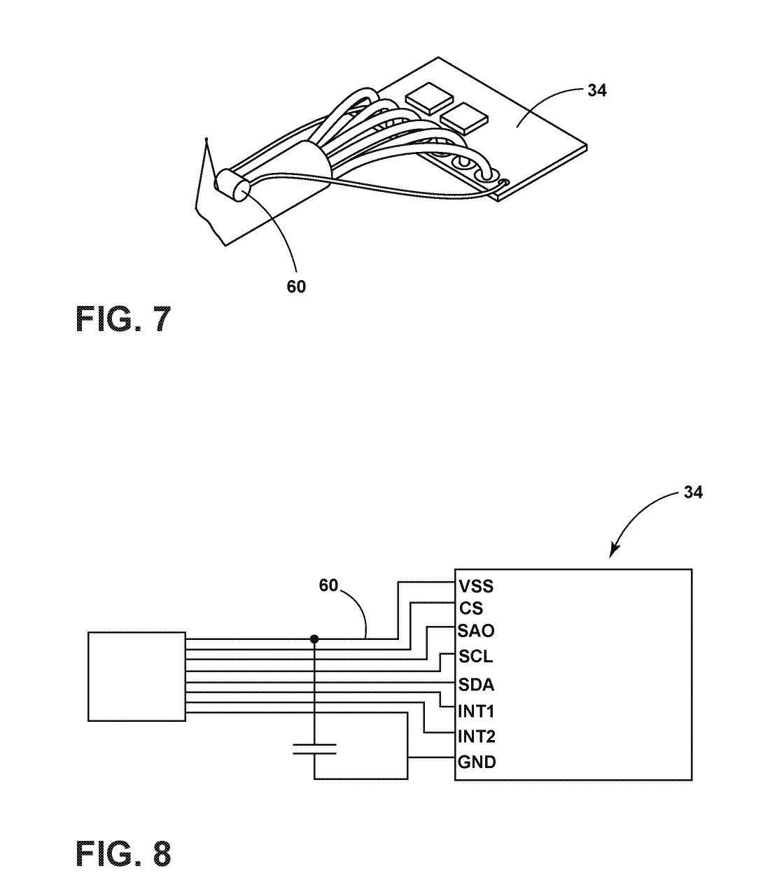

In one particular embodiment of a punching bag 32 according to the present disclosure, the accelerometers selected for use with the punching bag 32 are able to withstand forces of 24 g (g=9.80665 m/s²). One example of a suitable accelerometer for use on this punching bag 32 embodiment is an LIS331HH accelerometer, as shown in FIGS. 7-8, which is a three-axis accelerometer which has a programmable low pass filter and interrupts, and is capable of serial communication.

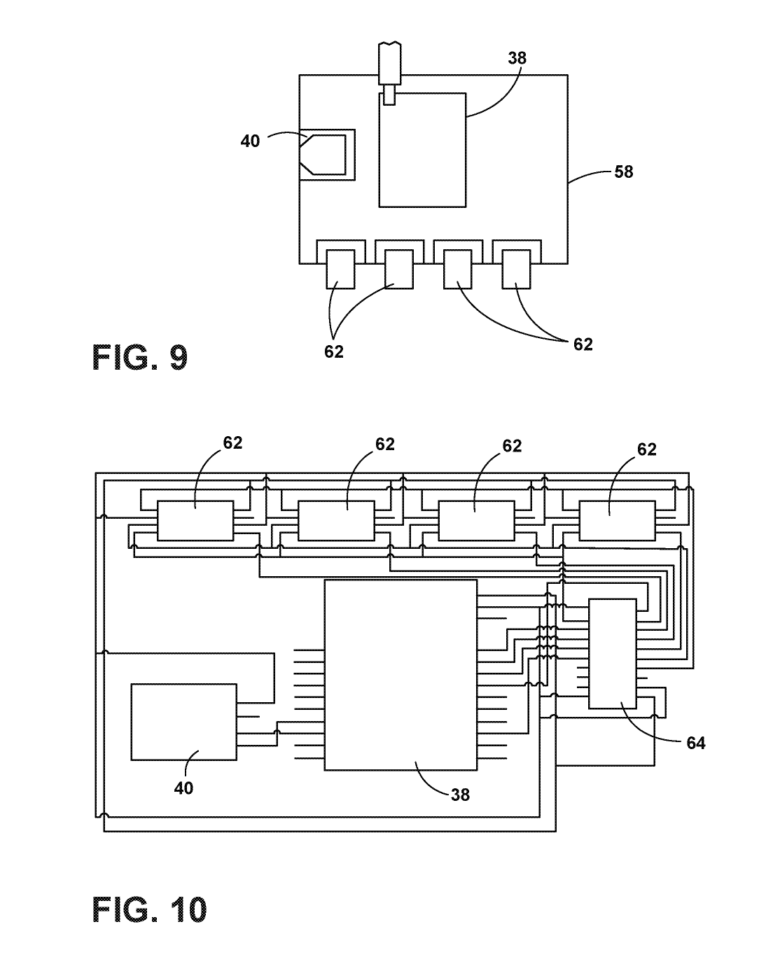

Also, as generally shown in the embodiment illustrated in FIGS. 4-6, the microcontroller 38 is positioned on the distribution board 58, which is located on the top of the punching bag 32 on the stand 56, out of the range of the strike zone on the punching bag 32. Each of the accelerometer sensors 34 as shown in FIGS. 7-8 is hard-wired to the microcontroller 38, as shown in FIGS. 9-10. The distribution board 58, as shown in FIGS. 9-10 includes four RJ45 connectors 62, a MSP430 G2553 model microcontroller 38, and a wireless communication transmitter 40 such as a wireless serial port device (XBee series 1 [802.15.4]). All pins of the connectors 62 are electrically connected through a buffer 64 to the MSP430 microcontroller 38. The MSP430 microcontroller 38 is then connected to the wireless communication transmitter 40. The wireless communication transmitter 40 of the distribution board 58 transmits sensor data 36 wirelessly to a wireless communication receiver 42 which is operably connected to the processing device 44. Table 1 below includes a listing of the electrical parts used in the particular embodiment shown in FIGS. 4-10 to measure the force and frequency of strikes against the punching bag 32.

TABLE 1
Bill of Materials for Interactive Punching Bag Electronics

| | | | Manufacturer |
|---|---|---|---|
| Part Name | Description | Manufacturer | Part No. |
| XBee Explorer | Breakout board for XBee Module to | Sparkfun | WRL-11373 |
| Regulated | mount to distribution board | Electronics | |
| XBee Adapter kit- | Breakout board for XBee Module to | Adafruit | 126.00 |
| v1.1 | connect to the host PC via FTDI Cable | Industries | |
| FTDI Serial TTL- | FTDI cable to connect XBee Adapter to | Future | TTL-232R- |
| 232 USB Cable | host PC | Technology | 3V3 |
| | | Devices | |
| | | International | |
| | | Ltd. | |
| XBee 1 mW Wire | XBee Module to preform wireless | Digi | XB24-AWI- |
| Antenna—Series 1 | UART communication | International | 001 |
| (802.15.4) | | | |
| Jumper Wires | Jumper wires used for preliminary | Sparkfun | PRT-09140 |
| Premium 6″ M/F | testing of accelerometers, and XBee | Electronics | |
| Pack of 10 | Modules | | |
| 12′ micro-USB to | Micro-USB cable used to power the | PWR+ | 533-PWR57- |
| USB Cable | entire system via a USB Wall Charger | | 54723 |
| xGen Home Travel | USB wall charger used to power the | xGen | N/A |
| Wall AC Charger | system via a standard wall outlet | | |
| USB | | | |
| Female Headers | Break-away female header pins used for | Not Listed | Not Listed |
| | initial phases of testing with the Xbee's | | |
| Male Headers | Male headers used for mounting | Not Listed | Not Listed |
| | breakout boards to the distribution board | | |
| 25′ Spool of Solid | General hookup wire used for initial | Guasti Wire | HS22-06-25 |
| Core Hookup Wire | testing phases/wiring of the distribution | | |
| (Blue) | board | | |
| 25′ Spool of Solid | General hookup wire used for initial | Guasti Wire | HS22-02-25 |
| Core Hookup Wire | testing phases/wiring of the distribution | | |
| (Red) | board | | |
| 25′ Spool of Solid | General hookup wire used for initial | Guasti Wire | HS22-04-25 |
| Core Hookup Wire | testing phases/wiring of the distribution | | |
| (Yellow) | board | | |
| 25′ Spool of Solid | General hookup wire used for initial | Guasti Wire | HS22-05-25 |
| Core Hookup Wire | testing phases/wiring of the distribution | | |
| (Green) | board | | |
| Triple Axis | Breakout board with a LIS331 | Sparkfun | SEN-10345 |
| Accelerometer | accelerometer and drivng components | Electronics | |
| Breakout-LIS331 | | | |
| 1″ Black Knitted | Roll of knitted elastic band used to | Not Listed | Not Listed |
| Elastic Roll 50 | secure the accelerometers to the bag | | |
| yrds | | | |
| RJ45 Ethernet | Breakout board with RJ45 pin spacing | Sparkfun | PRT-08790 |
| Breakout Board | used to mount the RJ45 connectors to | Electronics | |
| | distribution board | | |
| RJ45 8-Pin | RJ45 8-pin connectors used to connect | Not Listed | Not Listed |
| Connector | the ethernet cables connected to the | | |
| | accelerometers to the distribution board | | |
| MSP430G2553 | MSP430G2553 Microprocessor mounted | Texas | MSP- |
| Launchpad | on the Launchpad Development board | Instruments | EXP430G2 |
| | from TI | | |
| Amzer Dual | Used to split the Micro-USB cable | Amzer | AMZ85746 |
| Micro-USB | connected to wall charger to separate | | |
| Splitter | to power the MSP430, and XBee cables | | |
| | Module | | |
| BELKIN R6G088- | Ethernet cable ends to connect to one | BELKIN | R6G088- |
| R-10 RJ45 Plug | end of the bulk Cat5e cable, while other | | R-10 |
| | end connects to accelerometer | | |
| Micro-USB to | Used to convert Micro-USB cable to | SF Cable | Not-Listed |
| Mini-USB Adapter | Mini-USB to power the MSP430 | | |
| HeatShrink Tubing | Heat shrink tubing used to cover | Qualtek | Q2-F4X-2- |
| | components mounted to bag, and PC | | 01-QB48IN-5 |
| | dongle for Xbee Module | | |
| RadioShack Grid- | PC Board with 2200 Holes, used as the | RadioShack | 276-147 |
| Style PC Board | main distribution board for the entire | | |
| with 2200 Holes | project | | |

The processing device 44 used with the embodiment depicted in FIGS. 4-10 pulls data from the accelerometer sensors 34 every 4 ms in a round-robin configuration, and uses the average value of the sensor data 36 over the most recent 5 seconds to determine whether the at least one predetermined performance goal has been met over that 5 second time period. The processing device 44 can continue to perform this calculation, to determine a moving average and continue to update the feedback to the user.

In addition to sensor data 36 from accelerometer sensors 34, the system may include one or more external (e.g. wearable) sensors 22A (FIG. 1) that are worn by a user. The external sensors 22A may be utilized to measure acceleration and/or position and/or other variables to permit additional metrics of the user's performance to be measured. For example, a wearable sensor as disclosed in U.S. Pat. No. 9,120,014 may be utilized to track the performance of the user. Commercially available wearable sensors that are disposed in the boxer's gloves may also be utilized to track the performance of the user. Sensors of this type are available from Hykso, Inc. These sensors may be connected to a smartphone app which logs performance data. These wearable sensors track fitness metrics such as force, frequency/speed, accuracy, and heart rate of the user's performance.

Known wearable fitness sensors may be enhanced with the addition of audio based feedback concerning the metrics already gathered by these sensors. By integrating the music based feedback into these fitness sensors, the user's real time performance may be monitored by the wearable sensors and the user's chosen music may be altered based on the user's performance during physical activity.

Wearable sensors could be utilized instead of, or in combination with, sensors (e.g. accelerometers 34) (FIGS. 4 and 6) that are positioned on an exercise device. Wearable sensors afford a portability that stationary equipment may not provide for activities such as boxing or track or road running. Wearable sensors also have the ability to collect performance data while a user is using different exercise equipment such as treadmills, stationary bikes, or ellipticals. Additionally, performance data can be logged to smartphone applications which store performance data and have the ability to display real time data as well as post workout performance data. The sensor(s) attached to the user's body collect data about performance, store performance data for the user to track performance, and monitor real-time performance.

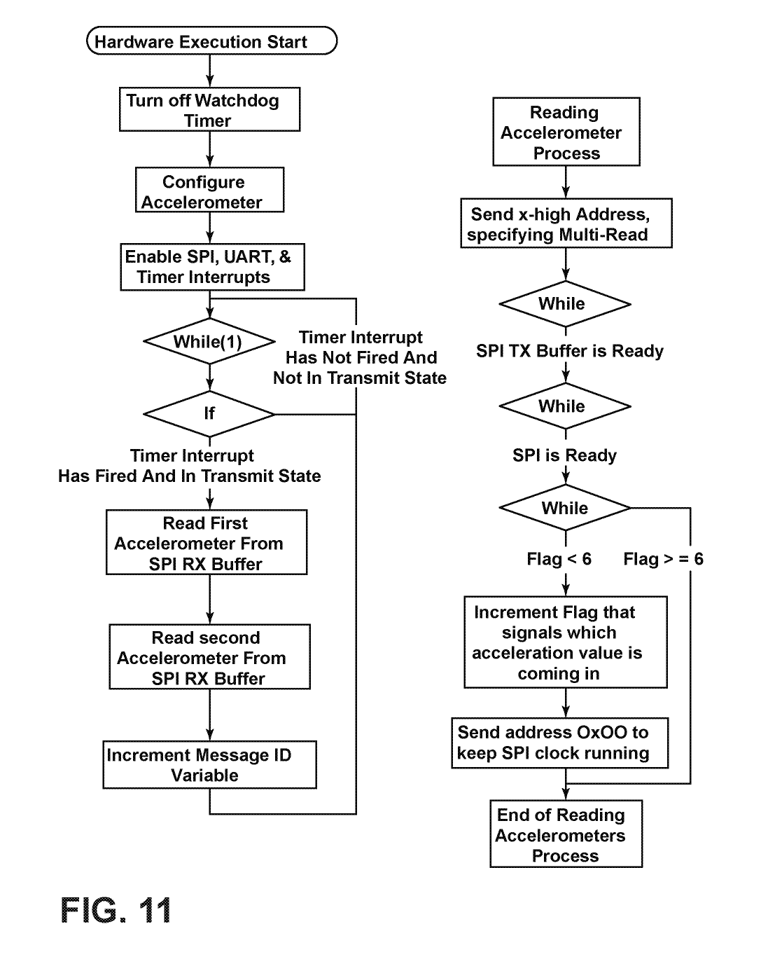

FIG. 11 is a flow chart of the main execution flow as well as the process of polling the accelerometer sensors 34 in the embodiment depicted in FIGS. 4-10. In use, the processing device 44 begins a round or session by initializing an SPI interface, a UART interface, the system clocks, and a timer module for execution. Next, the sensors 34 are configured and initialized with the setup parameters. Then the main execution starts an infinite loop where it repeatedly checks several state flags to determine whether the observation station has sent a signal to begin polling the sensors 34, or if the timer has proceeded enough to indicate that, it is time to poll the sensors 34 to get new sensor data 36. If the flag for transmission is set to indicate the sensors 34 should be polled, and the timer interrupt has gone off 3 times (i.e. 3 ms have elapsed since the last poll of accelerometer sensors 34), then the sensors 34 are polled for the new sensor data 36 values.

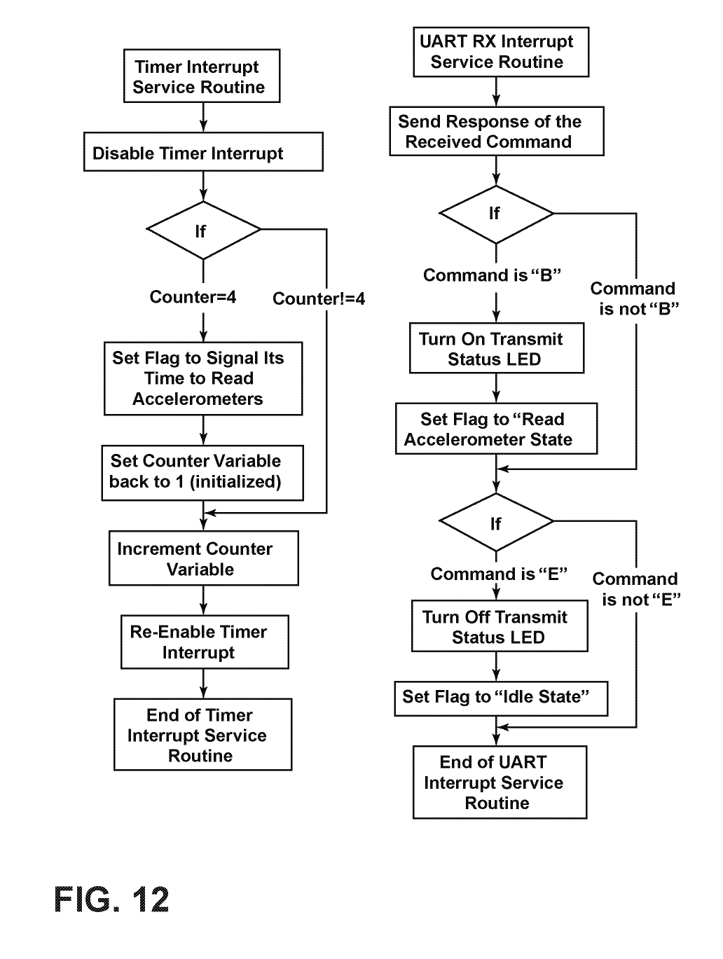

FIG. 12 illustrates the general flow diagram of a UART and timer interrupt handler in the embodiment depicted in FIGS. 4-10. The timer interrupt handler checks a global counter variable that increments each time the interrupt has gone off, until it reaches 3. When the global counter variable reaches 3, the state flag signals that it is time to poll the sensors 34 again and the counter is set back to 0. The UART Interrupt handler checks the received character to determine if it is a “B” or if it is an “E.” If the character received is a “B” the state flag is set to signal that the sensors 34 need to be polled continuously. If the character received is an “E,” the state flag is set to signal that the hardware should be idle and stop polling/sending the sensor data 36 to the processing device 44.

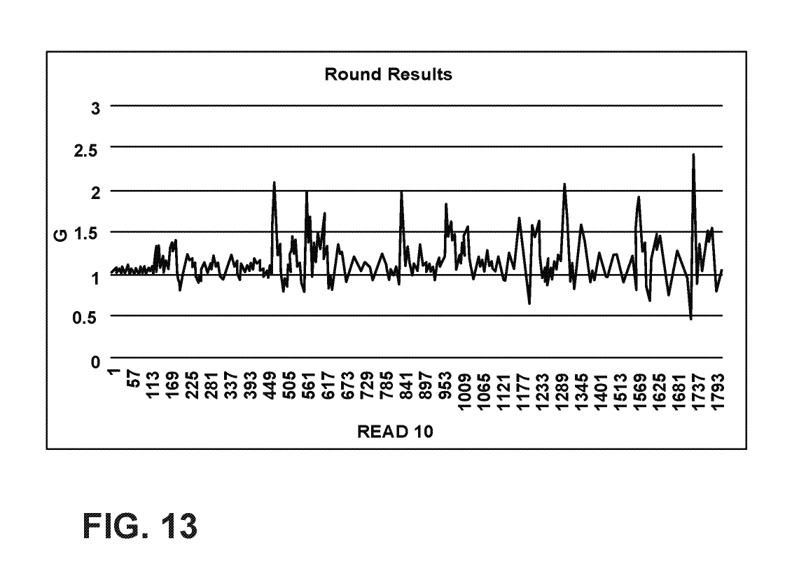

A typical set of sensor data 36 for the user's round on the punching bag 32 depicted in FIGS. 4-10 is shown in FIG. 13. This sensor data 36 is evaluated by the processing device 44 to determine strike force, strike frequency, and strike accuracy and to compare these values to predetermined performance goals, as described above. The processing device 44 directs audio feedback and visual feedback to the user, allowing the user to see real time feedback regarding the user's achievement of the at least one predetermined performance goals. The processing device 44 as described in this embodiment would then compare the frequency, the force, and the accuracy of the strikes with the at least one predetermined performance goals, which are calculated as described above. If the strike frequency over the most recent 5 seconds is below the predetermined performance goal for frequency, the processing device directs the audio feedback module 48 to slow the tempo of the music being played. If the strike frequency meets or exceeds the predetermined performance goal for frequency, the music is played at its original tempo. The strike frequency may be calculated determined for a series of successive predefined time periods of, for example, 5 seconds. The time periods may be in a range from 1 second or less to 10 seconds or more (e.g. 30 or 60 seconds). Similarly, if the strike force is below a predetermined performance goal for the force of the strike, the volume of the music is lowered and if the strike force meets or exceeds the predetermined performance goal for the force of the strike, the volume of the music is retained at the original level.

In various alternative embodiments force measurements, frequency measurements, and accuracy measurements can be used to evaluate a user's performance on many different types of exercise equipment 20, including without limitation free weights, a stationary bike, a treadmill, a rowing machine, a stair stepper, and an elliptical trainer. Examples of the types of force, frequency, and accuracy measurements and sensors 22 for each of these types of equipment 20 are described in Table 2 below.

TABLE 2
Alternate Embodiments

| | | Frequency | Accuracy |
|---|---|---|---|
| | Force Metric | Metric | Metric |
| Free | Weight | Break between | Balance of force |
| Weights | | repetitions | from each hand |
| | Accelerometer | Accelerometer | Accelerometer |
| Stationary | Resistance | Speed | Balance |
| Bike | Strain Gauge | Accelerometer | Accelerometer |
| Treadmill | Force of Step | Treadmill | Steps aligned to |
| | | speed | center (foot |
| | | | placement) |
| | Accelerometer | Accelerometer | IR Sensors |
| Rowing | Resistance | Speed | Straightness, |
| Machine | | | balance of forces |
| | Strain Gauge | Accelerometer | Accelerometer |
| Stair | Force on Step | Speed | Foot placement |
| Stepper | Accelerometer | Accelerometer | Force Sensing |
| | | | Resistor |
| Elliptical | Pressure on plates | Speed | Even workload |
| | Accelerometer | Accelerometer | Accelerometer |

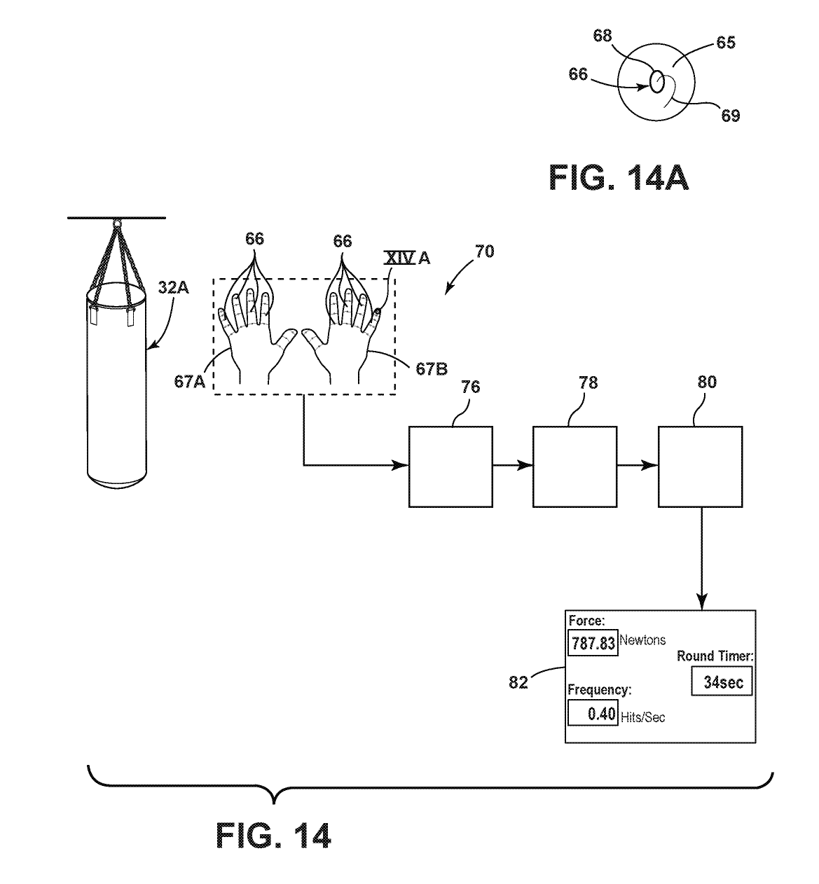

With further reference to FIG. 14, a system 70 according to another aspect of the present disclosure includes a punching bag 32A that may optionally include accelerometers 34 as discussed in more detail above in connection with FIGS. 4-6. One or more wearable sensors 66 may be positioned on the hands 67A and/or 67B of a user and/or in boxing gloves (not shown) that are worn by a user. With reference to FIG. 14A, sensors 66 generally include a pad or base 68 that is adhesively secured to the skin 65 of the user's hands 67A, 67B, and one or more data lines 69 that may be utilized to operably connect the sensors 66 to a microcontroller 76. The microcontroller 76 is operably connected to a wireless transmitter 78, which wirelessly transmits data 79 to a wireless receiver 80. The receiver 80 is operably connected to a display screen 82. The display screen 82 may be provided by a smartphone, computer, or other suitable device. The display screen 82 provides information such as the average force of each impact measured by sensors 66, the frequency of the hits, and the elapsed time for a round or exercise session. The sensors 66 may comprise piezoelectric devices that measure the force of the impacts on punching bag 32. The data from sensors 66 may be combined with data from accelerometers 34 (FIGS. 4-6), and the screen 82 may be utilized to provide feedback to a user based on both accelerometer data and wearable sensor data.

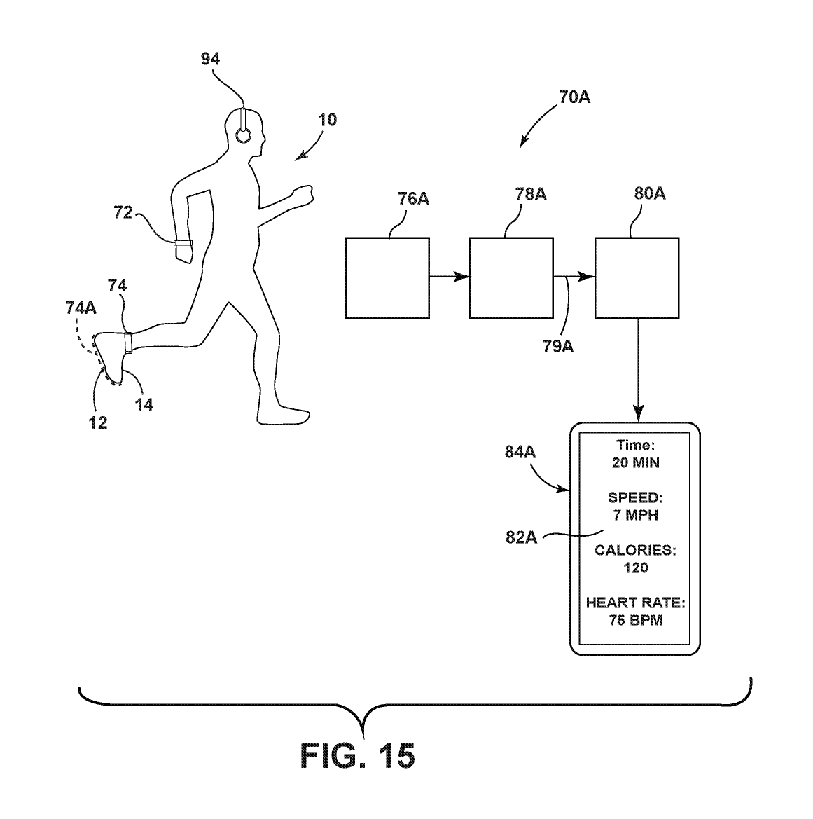

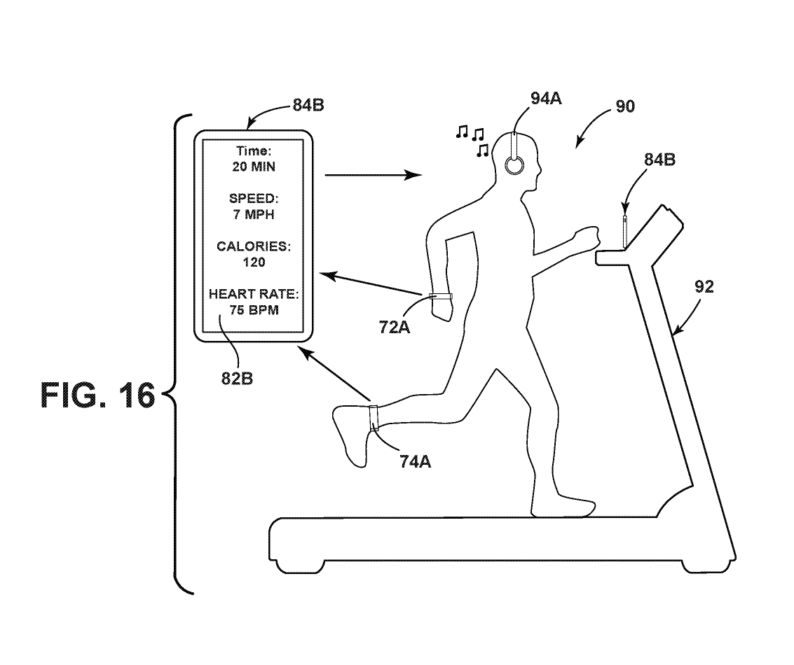

With further reference to FIG. 15, a system 70A includes wearable sensors 72 and 74 that may be worn by a user 10. The sensors 72 and 74 are operably connected to a microcontroller 76A, and provide data to the microcontroller 76A. The wearable sensors 72 and 74 may have wireless transmitters that operably connect the sensors 72 and 74 to the microcontroller 76A, or the sensors 72 and 74 may be connected directly via data lines or the like (not shown). Sensors 72 and 74 may comprise accelerometers.

One or more a piezoelectric sensors 74A may be positioned on a bottom 12 of a user's foot 14. Piezoelectric sensor 74A uses the piezoelectric effect to detect mechanical stress from the building of an electric charge. This pressure produces a differential electrical charge proportional to the force exerted. Piezoelectric sensor 74A is operably connected to microcontroller 76A utilizing a wireless connection or data lines (not shown) and transmits data to microcontroller 76A. This data is converted into both force and frequency data utilizing microcontroller 76A to interpret the data from piezoelectric sensor 74A.

The microcontroller 76A is operably connected to a wireless transmitter 78A, which wirelessly transmits data 79A to a wireless receiver 80A. The wireless receiver 80A is operably connected to a device such as a smartphone 84A having a display screen 82A. The smartphone 84A may be configured to display information such as the elapsed time, speed at which the user 10 is running, the calories consumed, heart rate, etc. The wearable sensors 72 and/or 74 and/or 74A may comprise accelerometers or piezoelectric sensors that may be configured to provide details concerning running performance, including the force of foot impact, speed of run, and overall balance. Feedback regarding accuracy may be delivered to the user 10 via screen 82A by examining the location of the impact (e.g. uneven distribution of force). If sensors 72 and 74 comprise accelerometers located in wrist and foot bands, microcontroller 76A may be configured to detect performance data and alter music to a user's headset 94 based on the performance data.

With further reference to FIG. 16, wearable accelerometers 72A, 74A may be worn by a user. In the illustrated example, the sensor 72A is retained via a wrist strap, and sensor 74A is retained by an ankle strap. It will be understood that the sensors may also comprise piezoelectric devices that are configured to detect forces as discussed above in connection with FIG. 15. The system 90 of FIG. 16 is similar to the system 70A of FIG. 15, and further incorporates a treadmill 92. The treadmill 92 may be operably connected to the microcontroller 76A via wireless transmitter 78A, and the treadmill 92 may be operably connected to a user's smartphone 84B. The data from sensors 72A and 74A allows the microcontroller 76A to alter music as a form of feedback based on the measured data. For example, the tempo of the music may be altered to provide feedback as discussed in more detail above.

It will be understood that the method and system of the present disclosure may be utilized in connection with various exercise devices in addition to the treadmill 92. For example, the system may be utilized in connection with free weights, stationary bikes, rowing machines, stair steppers, elliptical machines, and the like.

It is also important to note that the construction and arrangement of the elements of the exercise equipment 20 and system 30 for providing performance feedback as shown and described in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. A method of providing interactive performance feedback for a user during a session of using exercise equipment, the method comprising:
providing an external sensor that is worn on a body of a user;
measuring user input during the session using the at least one external sensor to gather external sensor data;
transmitting the external sensor data to a processing device;
evaluating the external sensor data utilizing the processing device to determine at least one of a force metric, a frequency metric, and an accuracy metric;
comparing the at least one of the force metric, the frequency metric, and the accuracy metric to at least one predetermined performance goal; and
providing feedback to the user during the session based on the comparison of the at least one of the force metric, the frequency metric, and the accuracy metric with the at least one predetermined performance goal.

2. The method of claim 1, wherein:
the external sensor comprises an accelerometer.

3. The method of claim 1, wherein:
the external sensor comprises a force sensor.

4. The method of claim 1, wherein:
the feedback comprises at least one of audio and visual feedback.

5. The method of claim 1, wherein:
the exercise equipment is selected from a group consisting of free weights, stationary bikes, treadmills, rowing machines, stair steppers, and elliptical machines; and
the at least one external sensor comprises an accelerometer.

6. The method of claim 5, wherein:
the at least one external sensor comprises an accelerometer configured to generate data from which a frequency metric can be determined.

7. The method of claim 1, wherein:
the exercise equipment includes a movable member that moves in a repetitive manner defining a frequency in response to a force applied by a user of the exercise equipment; and
the at least one sensor comprises an accelerometer;
utilizing the processing device to determine a frequency of the movement of the movable member.

8. The method of claim 7, wherein:
the movable member comprises a pair of pedals that are configured to move in response to forces applied thereto by a user's feet.

9. The method of claim 1, wherein:
the accuracy metric comprises foot placement.

10. The method of claim 9, wherein:
foot placement is measured utilizing at least one body camera sensor.

11. The method of claim 1, wherein:
the external sensor comprises an implantable sensor chip.

12. The method of claim 1, wherein:
the external sensor comprises a body camera sensor that allows motion capture of body movement by collecting depth data within a three-dimensional field using infra-red dot positioning to calculate a depth of pixilation in a red/green/blue spectrum.

13. The method of claim 1, including:
providing an integrated sensor that is mounted to the exercise equipment;
utilizing integrated sensor data from the integrated sensor to determine if a user has met at least one predetermined performance goal.

14. The method of claim 1, including:
providing audio in the form of music, wherein the processing device sorts the music according to predefined criteria to initially provide music having a first number of beats per minute during an initial warmup period, followed by music having a second number of beats per minute, wherein the second number of beats per minute is greater than the first number of beats per minute.

15. A method of providing interactive performance feedback for a user during a session of using exercise equipment, the method comprising:
measuring user input during the session using at least one sensor to gather sensor data;
transmitting the sensor data to a processing device;
evaluating the sensor data utilizing the processing device to determine if a user is meeting at least one predetermined performance goal;
providing audio in the form of music having variable beats per minute, wherein the music is selected to provide a number of beats per minute based on an expected exercise performance metric by a user.

16. The method of claim 15, wherein:
the exercise equipment is configured to provide cyclical movement of a user's arms and/or legs during use to define a frequency, and wherein the number of beats per minute is selected to correspond to a predefined frequency goal.

17. The method of claim 16, wherein:
the exercise equipment comprises a treadmill that moves at a walking rate, a jogging rate, and a running rate, and wherein the processing device provides a beats per minute for the walking rate that is about 100-110, and a beats per minute for the jogging rate that is about 110-140, and a beats per minute for the running rate that is about 140-160.

18. The method of claim 16, wherein:
the exercise equipment comprises a stationary bike having pedals that move to define a variable pedal rate;
the processing device is configured to provide music having a beats per minute that increases following an initial warm up period.
